(19) United States
(12) Patent Application Publication
(10) Pub. No.: US 2003/0127408 A1
(43) Pub. Date: Jul. 10, 2003

(54) Anti-two block wire internal to crane telescopic boom

(75) Inventor: William D. Schneider, Malcom, NE (US)

Correspondence Address: BIRCH STEWART KOLASCH & BIRCH, PO BOX 747, FALLS CHURCH, VA, 22040-0747, US

(73) Assignee: National Crane Corporation

(21) Appl. No.: 10/368,428

(22) Filed: Feb. 20, 2003

Related U.S. Application Data
(62) Division of application No. 09/659,506, filed on Sep. 11, 2000.
(60) Provisional application No. 60/177,215, filed on Jan. 21, 2000.

(51) Int. Cl. B66C 23/90

(52) U.S. Cl. 212/281

(57) ABSTRACT

A wire or cable is provided internally of an extensible boom to connect a switch, control or other element, such as an anti-two block switch, at one end of the extensible boom to elements or controls at the other end, such as controls for operating the crane. The wire or cable is itself inextensible, and is normally maintained taut. Wire control elements are provided to permit movement of the wire to accommodate extension and retraction of the telescopic boom sections. The wire internal to the extensible boom is fully protected from the environment and external hazards.

### CROSS REFERENCE TO RELATED APPLICATIONS

This application is a divisional of co-pending application Ser. No. 09/659,506, filed on Sep. 11, 2000, the entire contents of which are hereby incorporated by reference and for which priority is claimed under 35 U.S.C. §120.

### FIELD OF THE INVENTION

The invention relates to improvements in wiring arrangements for anti-two block devices for cranes.

### BACKGROUND OF THE INVENTION

During operation of a crane, if the hook block contacts the boom nose with enough force, the lifting cable could break and the hook block, along with the load, would fall to the ground. Such contact of the hook block and boom nose is called two-blocking, and is a particularly dangerous situation. Therefore, anti-two block devices are used as an operator aid on cranes to warn the crane operator that the hook block is approaching the boom nose. In some systems, in addition to providing a warning to the operator, control signals will be generated to lock out the hoist-up function or the telescope-out function for the boom so as to prevent further operation of the crane that would bring the hook block any closer to the boom nose.

Typically, an anti-two block device comprises a weight suspended by a chain from an electrical switch mounted on or near the boom nose of a crane. The weight fits around one of the falls of the lifting cable running from the hook block to the boom nose sheaves. The weight keeps the electrical contacts of the switch closed, and the crane operator can freely raise or lower the hook block and/or telescope the boom outwardly. If the hook block comes too close to the boom nose, the weight will be raised and the switch will open. Opening of the switch will generate a warning to the operator and, as noted above, may cut off any operation of the crane which would create further likelihood of two-blocking.

FIGS. 1-2 illustrate a typical anti-two blocking arrangement on an extensible crane boom. FIG. 2 is an enlarged view of the boom nose portion of the boom illustrated in FIG. 1.

As seen in FIG. 1, a typical extensible boom 10 may have, for example, a base section 12, a mid section 14, and a fly section 16, although the number of boom sections can vary from that illustrated. A boom nose portion 18 includes sheaves (not shown) for guiding the lifting cable 20. Lifting cable 20 supports a hook block (not shown) for lifting a load.

An anti-two block device might typically include a switch 22 mounted on boom nose portion 18, as best seen in FIG. 2. A weight 24 surrounds cable 20. Weight 24 is suspended by a chain or other linkage 26, and normally holds the electrical contacts closed in switch 22.

Switch 22 is provided with electrical power and is connected to a control panel in an operator's cab via, for example, a socket 28 associated with switch 22 and a plug 30 associated with an electrical wire 32. As seen in FIG. 1, wire 32 extends along the exterior of boom 10. Wire 32 is guided by a number of cable guides 34 associated with base section 12 and additional guides 36, 38 associated with the mid section and fly sections, respectively. Wire 32 may be used to carry power to switch 22 an/or to carry signals from switch 22 to the control cab of the crane.

A reel mechanism 40 is provided on the exterior of the base section. Reel 40 pays out and takes up wire 32 as the boom extends and retracts, respectively. As a result, wire 32 is maintained taut at all times during operation of the boom.

As discussed above, the contacts in switch 22 are normally maintained closed by weight 24. If the hook block closely approaches the boom nose 18, the hook block will lift weight 24, whereby the contacts within switch 22 will be permitted to open. As a result, appropriate control signals will be generated and transmitted to the control cab and/or the control panel of the crane via wire 32. A visual and/or audible warning of the situation may be provided to the operator, and certain functions of the crane may be disabled to prevent the operator from causing the hook block to more closely approach the boom nose.

Such a structure, as described with respect to FIGS. 1-2, has a number of drawbacks associated with it. The fact that reel 40 and wire 32 are mounted externally to the boom exposes the reel 40 and wire 32 to many external hazards. For example, wire 32 and/or reel 40 may sometimes be damaged by becoming snagged on tree limbs, either while in transport or during operation of the boom around trees. Wire 32 and/or reel 40 can also become snagged on other job-related objects or structures.

Exposure to the elements, ice, freezing rain, sleet and snow, can also cause problems with the wire or the reel. Being exposed to all of these hazards will sometimes result in wire 32 or reel 40 sustaining enough damage that the anti-two block device will no longer function properly.

Additionally, use of reel 40 requires that some mechanism be provided to maintain electrical continuity between the wire 32 on reel 40 and another conductor element that extends from reel 40 to the control panel of the crane as the reel rotates. This, together with reel 40, adds expense and complexity to the elements required to connect the anti-two block switch to the control panel, possibly also adversely affecting reliability.

### OBJECTS OF THE INVENTION

Accordingly, it is an object of the present invention to overcome the above-described drawbacks and limitations.

A particular object of the present invention is to overcome these drawbacks and limitations by providing a structure wherein the wire for providing power and electrical signals to and from an anti-two block device is positioned internally of an extensible boom where it is protected from the above-discussed hazards and elements.

Another object of the invention is to provide an anti-two block wiring arrangement that is simple and less prone to mechanical difficulties and failure.

### SUMMARY OF THE INVENTION

In accordance with the invention, a signal/power wire for an anti-two block device is positioned internally of the sections of an extensible boom. The wire length stays constant, eliminating any need for reels or other wire take-up devices.

In accordance with the invention, the wire power or signal wire is routed over pulleys and guide elements located strategically in the different boom sections to allow the boom to extend and retract while not requiring a variable length anti-two block wire.

### BRIEF DESCRIPTION OF THE DRAWINGS

The present invention will be better understood upon consideration of the following detailed description considered in conjunction with the accompanying drawings, in which:

FIG. 1 illustrates a typical extensible boom that includes an anti-two block device;

FIG. 2 is an enlarged view of the nose portion of the boom of FIG. 1;

FIG. 3 is a side sectional view illustrating a first embodiment of an extensible boom in accordance with the invention in an extended condition;

FIG. 4 is a side sectional view illustrating the boom of FIG. 3 in a retracted condition;

FIG. 5 is an enlargement of certain wire guiding elements of the embodiment of FIGS. 3-4 of the present invention;

FIG. 6 is a side sectional view illustrating a boom in accordance with a second embodiment of the present invention in a retracted condition;

FIG. 7 is a side sectional view of the boom of FIG. 6 in an extended condition;

FIG. 8 is a view of one section of a boom in accordance with the embodiment of FIGS. 6-7 illustrating details of the cable control arrangement; and

FIG. 9 is a partial end view of the embodiment of FIGS. 6-8 taken in the direction of arrow 9 of FIG. 8.

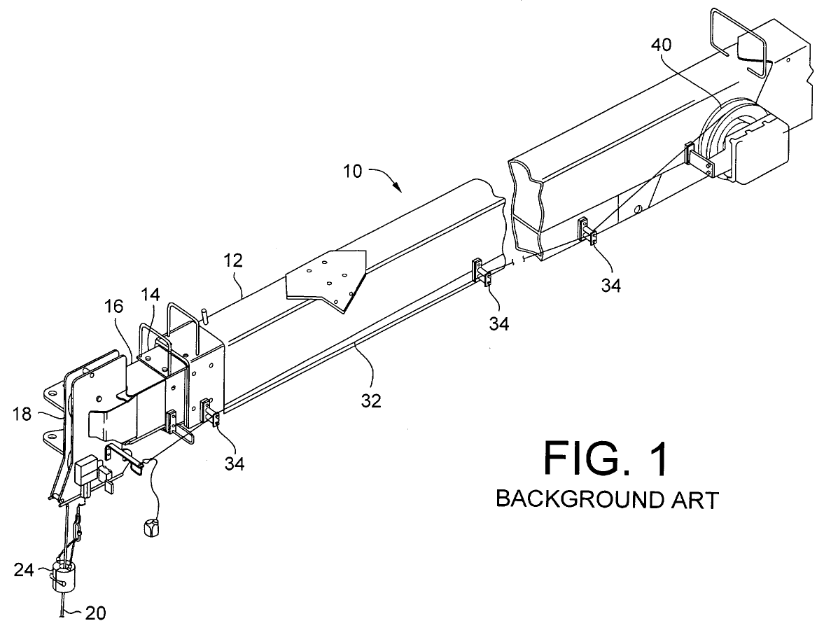

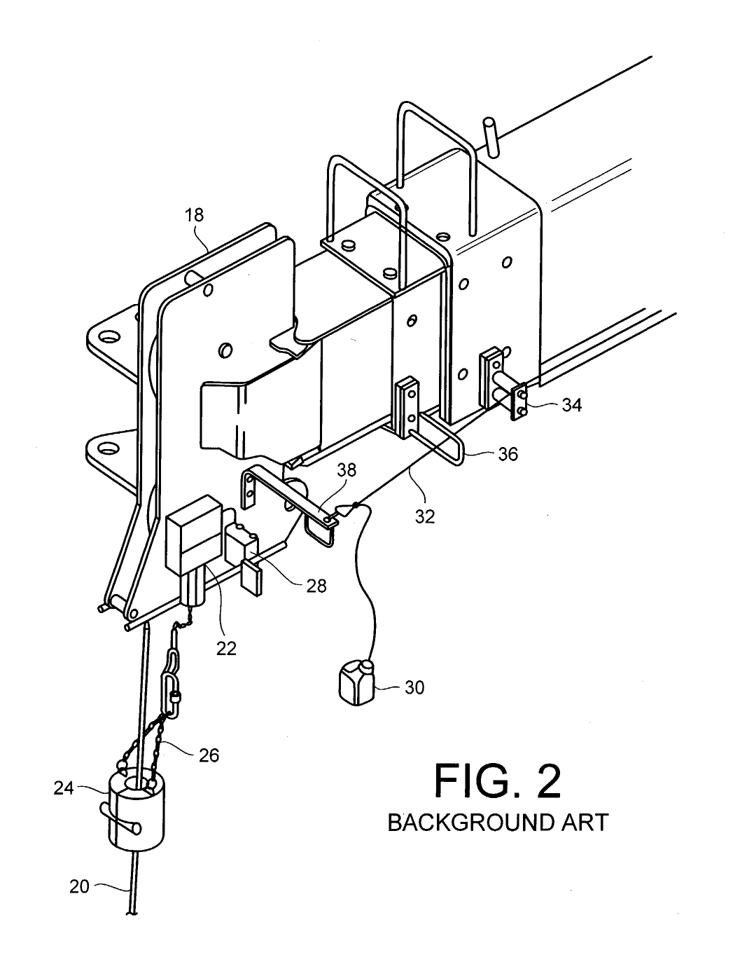

### DETAILED DESCRIPTION OF PREFERRED EMBODIMENTS

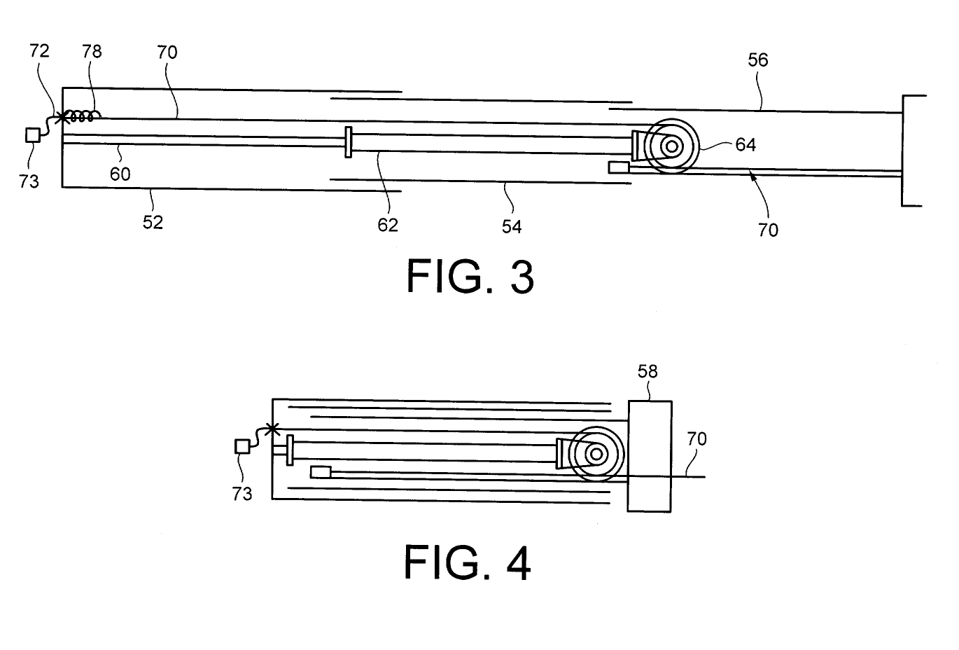

FIGS. 3-5 illustrate a first embodiment of the invention suitable for an extensible crane comprising an odd number of sections, such as three sections. Elements of the boom unnecessary to an understanding of the invention are omitted for clarity of illustration. In this exemplary embodiment, an extensible boom 50 includes a base section 52, a mid section 54, and a fly section 56. A boom nose 58 is positioned at the distal end of the fly section. A lifting cable (not shown) passes over sheaves (also not shown) in boom nose 58 in the normal fashion.

A typical boom extension mechanism includes a piston and cylinder device. In the example illustrated, an extension rod 60 is connected to base section 52, and an extension cylinder 62 is connected to the mid section 54 of the boom. Rod 60 is connected to a piston internal to cylinder 62, as is well known.

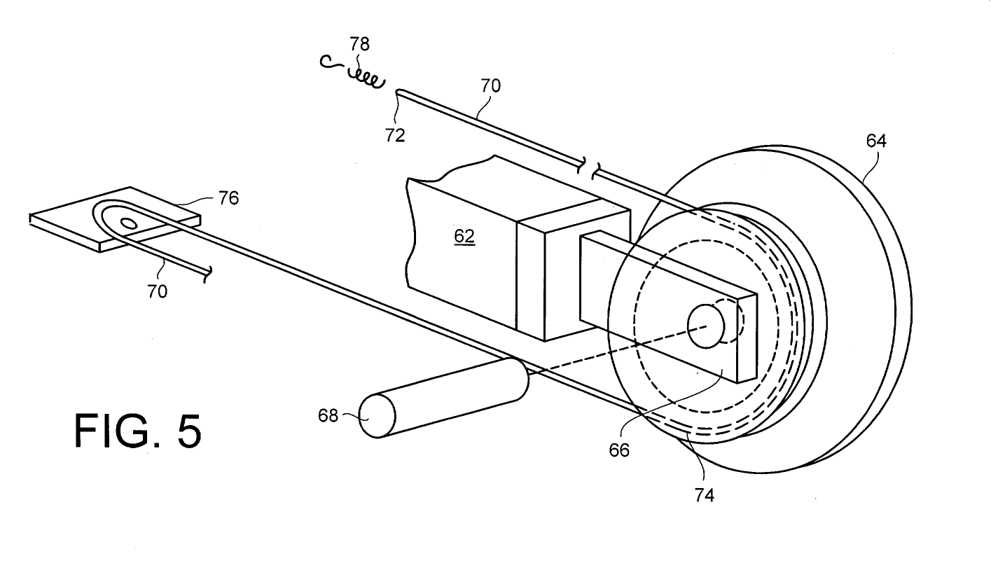

As best seen in FIG. 5, extension cable sheaves 64 are mounted on the end of extension cylinder 62 via supports 66 and an extension sheave pin 68. Typically, a pair of extension cable sheaves 64 are provided. In FIG. 5 only one sheave 64 is shown for clarity of illustration. Boom extension cables (not shown) are anchored to base section 52. The extension cables extend through the interior of the boom, over and about extension sheaves 64, and are then connected to the portion of the fly section 56 that is furthest from the boom nose 58.

To extend the boom, hydraulic fluid is provided under pressure to piston-cylinder device 60, 62, thus extending cylinder 62. As cylinder 62 extends, mid section 54 connected to cylinder 62 also telescopes outwardly with respect to the base section. Outward movement of extension sheaves 64 together with cylinder 62 causes fly section 56 to also telescope with respect to mid section 54 via the boom extension cables. The boom sections 54 and 56, thus, telescope synchronously and proportionately to extend the overall length of the boom. Retraction of the boom, of course, occurs in the opposite manner as a result of retraction of piston-cylinder device 60, 62 together with the extension cable pulleys 64 and the associated extension cables.

An anti-two block switch is provided at or near boom nose 58, to be connected to a wire 70 as indicated in FIG. 3. The anti-two block switch can take any form now known or later developed. The particular form of the anti-two block switch does not itself form part of the present invention.

According to the present invention, power and control signals pass between the anti-two block switch and a control panel in the control cab of the crane via the wire or cable 70. This wire or cable is located entirely within the interior of boom 50 throughout the length of the boom. Wire 70 is of constant length, and is substantially inextensible. Never the less, wire 70 is mounted in a manner to accommodate extension and retraction of the boom.

A first end 72 of wire 70 is anchored to base section 52. A connector, shown schematically at 73, can be provided to connect wire 70 to a further conductor that extends from the boom to connect to the control panel of the crane. Alternately, wire 70 can be extended past its anchor point at the base section 52 of the boom to itself extend from the boom to the control panel.

Wire 70 extends from its anchor point through the boom interior and passes over and around a wire pulley 74. In the embodiment illustrated, wire pulley 74 is carried on extension sheave pin 68 between extension cable sheaves 64. From pulley 74, wire 70 extends to, and is secured within a wire turnaround clamp 76 mounted on the interior of fly section 56. Wire 70 then extends through fly section 56 to boom nose 58 where it can be connected to an anti-two block switch.

As boom 50 extends and retracts, wire 70 follows a path similar to the boom extension cables. Wire 70 provides a power and signal path between an anti-two block switch located at boom nose 58 and the base of the boom so that connection can be made to a control panel in a control cab of the crane.

The length of wire 70 remains constant and the wire stays taut throughout extension and retraction of boom 50. A spring mount 78 may be provided adjacent one end of wire 70. Spring mount 78 keeps wire 70 taut despite small changes in boom length as a result of, for example, compression of hydraulic fluid within piston-cylinder device 60, 62.

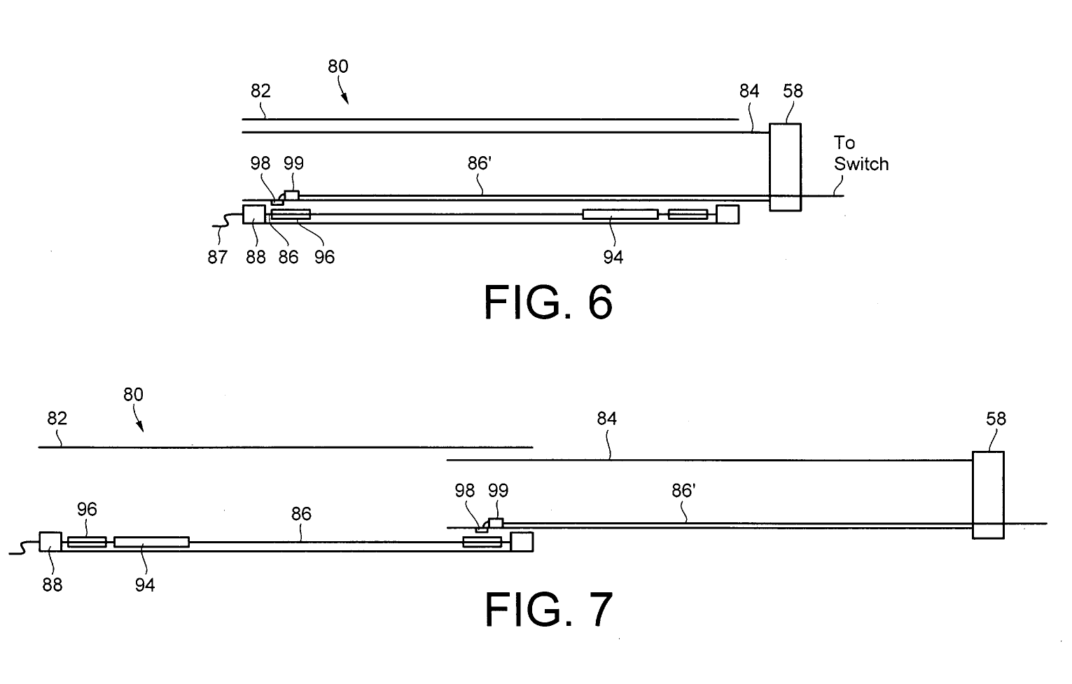

A second embodiment of the present invention will be described with respect to FIGS. 6-9. This embodiment is suitable for extensible booms having an even number of sections. The illustrated example comprises two sections. This embodiment is suitable for use between any two adjacent sections of an extensible boom, regardless of the total number of sections comprising the boom.

As illustrated in FIGS. 6-7, an extensible boom 80 is considered to comprise a base section 82 and a second section 84. In the drawing figure, section 82 is a base section such as would be mounted on a support structure of a crane. It is possible, as noted above, that section 82 is itself telescopic with respect to another lower section of the crane.

Second section 84 is telescopic with respect to base 82. As illustrated, section 84 is a fly section comprising a boom nose 58. As discussed above with respect to FIG. 3, boom nose 58 may comprise sheaves for carrying a lifting cable. It is to be understood, however, as noted above, that section 84 need not be a fly section. Rather, it may comprise any section that is telescopic with respect to an adjacent section.

Boom 80 comprises a device, not illustrated, to extend and retract section 84 with respect to section 82. This device may take any suitable form, such as a piston and cylinder device having portions connected to the sections, respectively, or any suitable equivalent.

A control wire or cable portion 86 is associated with base section 82. Another control wire or cable portion 86′ is associated with second section 84. These control cable portions may be connected to a control panel of the apparatus, such as by a connector cable 87, and to an anti-two block switch at or near boom nose 58.

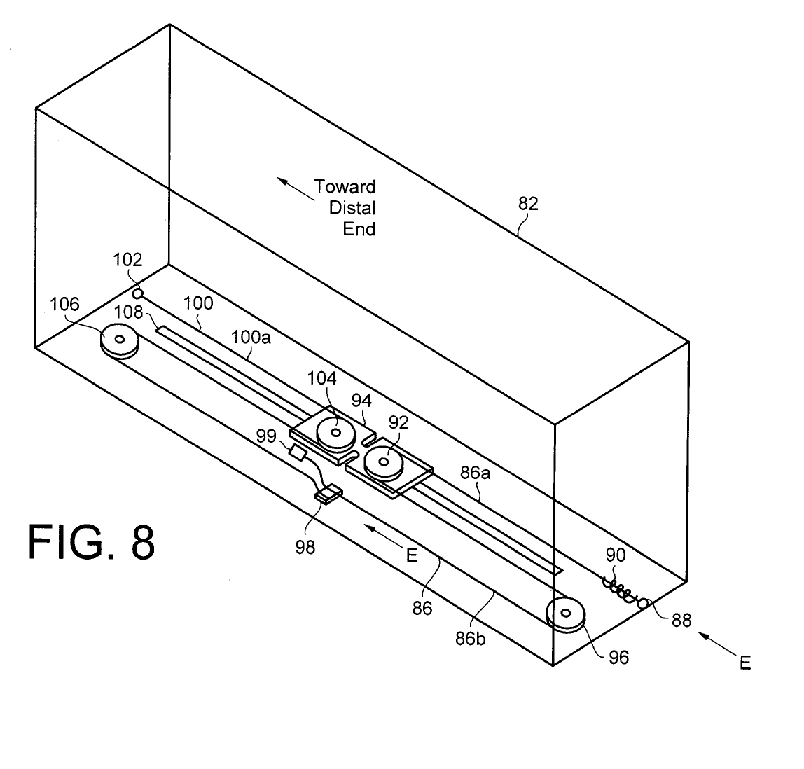

As best illustrated in FIG. 8, control cable portion 86 is anchored at an anchor point 88 adjacent the lower end of base section 82. Anchor 88 may include a spring, illustrated schematically at 90. Control cable 86, like wire or cable 70 in the above-described embodiment, is inextensible, and the cable control mechanism to be described hereinafter does not provide for changes in length of cable 86. Spring 90 may be provided, however, to keep cable 86 taut despite minor variations due to, for example, temperature changes, compression of hydraulic fluid or minor mechanical adjustments of the cable control mechanism.

Control cable 86 passes about a first sheave or pulley 92 associated with a traveling block 94. Cable 86 then passes about a guide pulley 96 mounted on base section 82. The other end of control cable 86 is secured in an anchor block 98. Anchor block 98 is mounted on second boom section 84 and is movable therewith. In the embodiment illustrated, the end-most portion of control cable 86 passes through a portion of second section 84 to be connected with control cable portion 86′. For convenience, a connector 99 may be provided for this purpose. When joined together, control cable portions 86, 86′ constitute essentially a continuous, inextensible control cable passing through the interior of the extensible boom.

The boom in accordance with this second embodiment further comprises tensioning cable 100. A first end of cable 100 is anchored to base section 82 at an anchor point 102. Tension cable 100 passes about a second sheave or pulley 104 associated with traveling block 94, and then about another guide pulley 106 mounted on base section 82. The other end of tension cable 100 is secured to anchor block 98.

The function of tension cable 100, together with traveling block 94, is to provide an equal and opposite tension force on traveling block 94 to balance the tension applied by control cable 86. As a result of this arrangement, the position of control cable portion 86, and the termination point of control cable 86 at anchor 98 and connector 99, can vary to accommodate extension and retraction of the telescopic boom in a manner to be described in greater detail hereinafter.

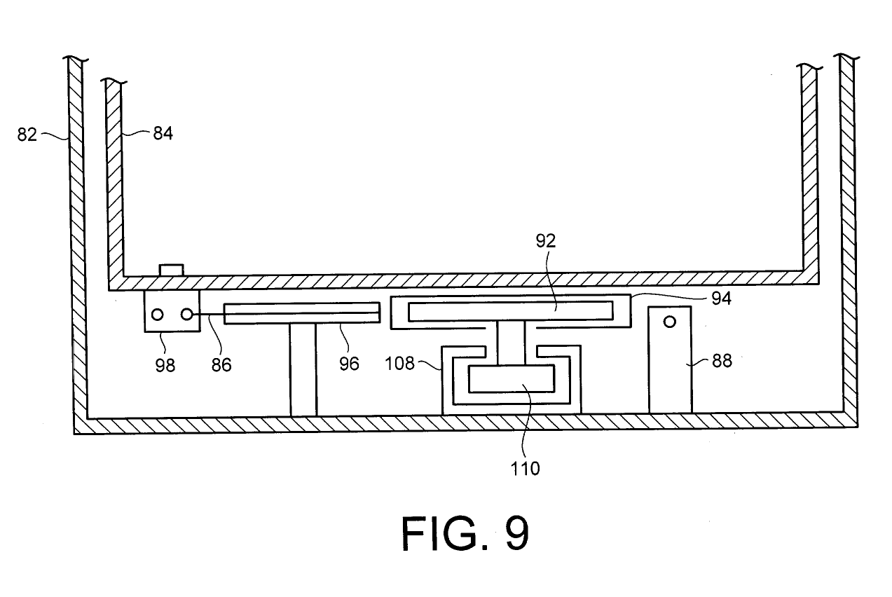

As seen in FIG. 8 and more particularly in FIG. 9, traveling block 94 is movable linearly with respect to base section 82 along a track 108. Track 108 may be formed as a channel, as is seen in sectional view in FIG. 9, or in any other suitable form. In the exemplary embodiment illustrated, rollers 110 are associated with sheaves 92 and 104. Such rollers cooperate with track 108 to facilitate movement of traveling block 94 in either direction along the track. In operation, block 94 travels along track 108 to permit control cable portion 86 to follow the extension or retraction of telescopic boom section 84.

When the boom is in a retracted condition, as illustrated in FIG. 6, anchor 98 associated with the lower end of telescopic section 84 is positioned generally near the lower end of base section 82. The end of tensioning cable 100 secured to anchor 98 is also drawn to the lower end of base section 82. As a result, traveling block 94 is caused to travel along track 108 toward the opposite, outer (upper) end of base section 82. This also can be seen in FIG. 6. In this configuration, the length of section 86a of cable portion 86 (see FIG. 8) is maximized and the length of portion 86b is minimized.

When boom section 84 is extended with respect to base section 82, anchor 98 travels with telescopic section 82 and moves away from the lower end of base section 82. This pulls control cable portion 86 outward in the direction of arrow E (FIG. 8). This increases the length of cable portion 86b to accommodate movement of the second boom section 84. To accommodate this movement, traveling block 94 travels along track 108 toward the lower end of base section 82, as illustrated in FIG. 7. As is evident from consideration of FIG. 8, simultaneously, movement of anchor 98 toward the upper or outer end of base section 82 permits portion 100a of tensioning cable 100 to lengthen, thereby permitting traveling block 94 to travel to the lower end of base section 82.

In accordance with this second embodiment of the present invention, a control cable can pass entirely through the interior of a two section extensible boom, achieving all of the advantages discussed above with respect to the embodiment of FIGS. 3-5. The embodiment of FIGS. 6-9 is not limited to the specific arrangement illustrated. For example, traveling block 94, cable portion 86, tension cable 100 and other associated elements can be associated with the second, telescopic section 84 while anchor 98 and cable portion 86′ can be mounted on base section 82. All that would be required to achieve this would be to reverse the position of all elements.

Additionally, while the embodiment of FIGS. 6-9 has been described as including a track such as shown at 108, that element is optional. In an apparatus constructed in the manner illustrated, with the arrangement of the anchor points 98 and 102 and the guide pulleys 96 and 106, the tension in cable portion 86 and cable 100 causes the travelling block 94 to travel in a straight line from one end of its traverse to the other without further guidance or control, such as from a track, being necessary.

It is also possible to combine the embodiments of FIGS. 3-5 and 6-9, respectively, in order to provide a control cable passing through the interior of an extensible boom having any number of sections. For example, the second embodiment of FIGS. 6-9 could be combined with the embodiment of FIGS. 3-5 to accommodate a boom having four sections. A plurality of control cable arrangements in accordance with the embodiment of FIGS. 6-9 could be included in association with a series of adjacent telescopic boom sections of a single boom having virtually any number of sections. Virtually any combination of the above embodiments may be adapted to accommodate specific needs and booms having particular numbers of telescopic sections.

The wire or cable arrangement according to the present invention satisfies all requirements for supply of electrical power to the boom nose for an anti-two block switch, or any other device requiring a connection for signals or power, and for returning control signals to the control cab. The internal wire is easily replaceable without disassembling the boom.

The anti-two block wire internal to a crane telescopic boom in accordance with the invention eliminates the drawbacks associated with a typical electrical reel and wire mounted externally of a boom. When employing a wire/cable arrangement according to the invention, there can be no physical contact between the wire internal to the boom and external hazards such as tree limbs and other objects. Also, the wire is not exposed to the elements as in the previously-known arrangements.

While the present invention has been disclosed and described with respect to a control wire or cable internal to an extensible crane boom and an anti-two block switch, it is not so limited. An internal control cable arrangement in accordance with the invention is suitable, for example, for connecting controls at the platform on the end of a boom in an aerial work platform to controlled devices mounted at or near the base of the boom. An arrangement in accordance with the invention is suitable to connect any device or control at one end of an extensible boom to another device or control at the other end of the boom.

1. An extensible boom comprising
a plurality of boom sections including at least a first section and at least one additional section telescopic with respect to said first section;
a signal wire of substantially constant length extending from said first section to the distal end of the telescopic section which is extensible furthest from said first section; and
a wire control element, said wire control element being movable for accommodating movement of said signal wire during telescoping of said boom sections.

2. An extensible boom as in claim 1, wherein said signal wire is positioned internally of said boom sections.

3. An extensible boom as in claim 1, wherein said wire control element includes at least one sheave.

4. An extensible boom as in claim 1, further comprising an anti-two block device positioned adjacent to the distal end of the boom, wherein said signal wire is connected to said anti-two block device.

5. An extensible boom as in claim 1, wherein said control wire is an electrical wire.

6. An extensible boom as in claim 1, further comprising means for maintaining said inextensible control wire taut.

7. An extensible boom as in claim 1, comprising at lease a first section, an intermediate section, and a third section, wherein said signal wire extends from the lower portion of said first section to the distal end of said third section.

8. An extensible boom as in claim 7, wherein said signal wire is continuous from the lower portion of said first section to the distal end of said third section.

9. An extensible boom as in claim 7, wherein said boom includes an extender connected to said sections for extending and retracting said telescopic sections, and said wire control element is associated with said extender.

10. An extensible boom as in claim 9, wherein said wire control element comprises a sheave mounted on said extender.

11. An extensible boom as in claim 2, comprising at lease a first section, an intermediate section, and a third section, wherein said signal wire extends from the lower portion of said first section to the distal end of said third section.

12. An extensible boom as in claim 11, wherein said boom includes an extender connected to said sections for extending and retracting said telescopic sections, and said wire control element comprises a sheave mounted on said extender.

13. An extensible boom as in claim 1, comprising a first section and a second section adjacent to said first section, said control wire extending from he lower part of said first section to the distal end of said second section.

14. An extensible boom as in claim 13, wherein said wire control element comprises at least one sheave movable with respect to at least one of said sections.
